(19) United States
(12) Patent Application Publication
(10) Pub. No.: US 2007/0230429 A1
(43) Pub. Date: Oct. 4, 2007

(54) ON-BOARD CDMA COMMUNICATION NETWORKFORECAST

(75) Inventor: Christian SANNINO, MURET (FR)

Correspondence Address: LOWE HAUPTMAN & BERNER, LLP, 1700 DIAGONAL ROAD, SUITE 300, ALEXANDRIA, VA, 22314, US

(73) Assignee: THALES, NEUILLY SUR SEINE (FR)

(21) Appl. No.: 11/669,934

(22) Filed: Jan. 31, 2007

(30) Foreign Application Priority Data
Jan. 31, 2006 (FR) 06 00866

(51) Int. Cl. H04B 7/216

(52) U.S. Cl. 370/342

(57) ABSTRACT

The present invention relates to a CDMA communication network on board a carrier, the network connecting a plurality of equipment on board the carrier and grouped into domains, each piece of equipment comprising at least one partition, the partitions being able to intercommunicate via digital message exchanges conveyed on at least one shared medium, the shared medium possessing a bandwidth limiting the number of simultaneously exchangeable messages to N_{Limit}. Access controllers provide an interface between equipment partitions and a shared medium. Each piece of equipment includes an access controller. Shared media are passive components and provide an interface between access controllers of equipment in a domain.

### RELATED APPLICATIONS

The present application is based on, and claims priority from, French Application Number 06 00866, filed Jan. 31, 2006, the disclosure of which is hereby incorporated by reference herein in its entirety.

### FIELD OF THE INVENTION

The field of the invention is that of networks on board a carrier and more particularly on an aircraft for intercommunication between equipment on board the aircraft.

### BACKGROUND OF THE INVENTION

An aircraft, for example a passenger transport civil aircraft, has on board a large amount of equipment which has to be controlled and which has to be able to intercommunicate for exchanging avionics data. The functions provided by equipment on board aircraft are very diverse: they cover both the requirements associated with the passenger compartments like managing the ventilation and the smoke detectors, and the requirements associated with flying the aircraft like managing the landing gear, or managing the cockpit display screen. To connect up equipment contributing to the same function, so-called first generation networks have been designed, possessing a star architecture, as for example the networks complying with the ARINC 429 standard, in which equipment is directly connected through a dedicated link to the equipment with which it has to communicate. Subsequently, to reduce the complexity of the wiring in aircraft, a second generation of networks was employed, which are those that are fitted in the most recent aircraft models. Their architecture is built upon a multiplexed “bus” to which all the equipment is connected and on which all the messages exchanged by all the equipment are routed. The equipment has the ability to listen on the bus for a message intended for it. On such networks, it is ideally desirable that avionics data transmissions between equipment should meet the following constraints: segregation of data, determinism and availability of communications. Segregation relates to the ability of receiving equipment to “listen” for messages intended for it, transmitted by a particular transmitter, and especially of not being disrupted by nearby communications. Determinism of communications is defined here as a bounded and known delay beyond which it is certain that data will be received. Finally, availability of communication relates to the redundancy of inter-equipment links for overcoming any possible failure.

TDMA (Time Division Multiplex Access) technology is generally used in second generation networks, with digital signals. Each piece of equipment or each message occupies the whole frequency band allocated for communications but for a very short, defined period. Periodically, samples from one message are interpolated with samples originating from other messages, which are sorted on reception, offering the possibility of having several messages simultaneously cohabit on the same frequency. A mechanism for rotating messages and allocating data to each of them, then transmitting and extracting this data, ensures a coexistence of simultaneous communications. TDMA technology is also much used in radio-communications. In the state of the art, a second generation network, for example the ARINC 664 standard part 7 (also known as AFDX) implements a protected virtual link concept, meeting the segregation constraint. This protection is introduced thanks to transmission time laws in the network's transmitting elements and monitoring mechanisms in these laws at intermediate nodes of the network. The intermediate nodes of the network are, in fact, switching elements that enable the matter of sharing communications links to be resolved. These switching elements act as a buffer and handle message queues, they meet Ethernet IEEE 802.3 standards. The availability sought is achieved by ensuring a redundancy of links, which incidentally requires modifying the format of the messages exchanged with respect to that of the IEEE 802.3 standard. The presence of such switching elements involves special precautions being taken to prove that the determinism constraints are met.

The switching elements, also called switches, present other drawbacks: in the first place, they cause a random delay in the transmission of messages which can be of the order of several milliseconds. This is very detrimental when the data exchanged is used to supply servo control loops. Furthermore, the switches are complex devices: they are consequently expensive and relatively heavy. Finally, their failure rate, linked to their level of complexity, is high, which is detrimental to the value of the MTBF (Mean Time Between Failures) of the aircraft for which an extremely high level is sought. The design of aircraft on-board networks not requiring such switching elements is therefore a significant technical problem.

Two alternative technologies to TDMA are known, enabling communications to be established between equipment, or users, connected onto the same communication network, hardwired or wireless: they are FDMA (Frequency Division Multiple Access) technology and CDMA (Code Division Multiple Access) technology.

In FDMA technology, an operator splits a frequency band (channel) allocated to communications, into individual channels. One of these individual channels is allocated to each user, or to each message exchanged. In practice, a message is used to modulate a carrier frequency forming part of one of the individual channels. It is these different carriers thus modulated which are transmitted after juxtaposition. On reception, selective filters isolate the different carriers which are then demodulated. FDMA technology supports analogue or digital messages.

The major drawback of this technology is that it requires implementation of a large number of special transmission and receiving elements, for example several laser sources transmitting at specific wavelengths as well as associated photo receivers dedicated to receiving a particular signal, in the case of optical transmission.

Finally, Code Division Multiple Access technology is a multiple access method based on the principle of spectral spreading. This technology enables several users to share the same frequency band. The distinction between the various users is made thanks to a code which is uniquely assigned to each user. The codes are orthogonal to each other. To access a delivered message generated by a previously known transmitter, the message being delivered via a signal, a receiver just has to multiply, or rather produce a scalar product, of the signal with the code associated with this user. CDMA technology is employed in the fields of telecommunications and satellite positioning where it is mainly used for carrying messages via radio signals. In these fields, setting up power control mechanisms for transmitters may prove necessary in order to solve interference problems between users close to a transmitter and other users remote from the transmitter. These mechanisms can complicate the implementation of a CDMA network.

A communications network on board a carrier according to the prior art uses a physical, material medium to connect pieces of equipment assembled on the carrier, these pieces of equipment are not very far away from each other and accordingly such a communication network does not require power control mechanisms; on the other hand, it includes switches which are detrimental for several reasons.

The purpose of the invention is to overcome this drawback.

### SUMMARY OF THE INVENTION

More precisely, the subject of the invention is a CDMA communication network on board a carrier, the network connecting a plurality of equipment on board the carrier and grouped into domains, each piece of equipment comprising at least one partition, the partitions being able to intercommunicate via digital message exchanges conveyed on at least one shared medium, the shared medium possessing a bandwidth limiting the number of simultaneously exchangeable messages to N_{Limit}, characterized in that it comprises,
access controllers providing an interface between equipment partitions and a shared medium, each piece of equipment including an access controller;
shared media which are passive components and which provide an interface between access controllers of equipment in a domain.

Thus, the aircraft on-board CDMA network is compatible with second generation avionics network architectures; it is distinguished by a MAC (Media Access Control) layer based on the multiplexing properties of CDMA, the MAC layer acting as an interface between a software part controlling a node link and a physical medium. In particular, it can be used to establish communications between the aircraft's equipment and does not comprise complex switching elements which are expensive, heavy and detrimental to the aircraft's reliability.

### BRIEF DESCRIPTION OF THE DRAWINGS

Other characteristics and advantages of the invention will appear on reading the detailed description that follows, given as a non-restrictive example with reference to the accompanying drawings in which:

FIG. 1 shows the principle of a CDMA network diagrammatically;

FIG. 2 shows a CDMA network architecture on board an aircraft according to the invention;

FIG. 3 shows an internal architecture of a receiving access controller for equipment connected to a CDMA network according to the invention;

FIG. 4 shows an internal architecture of a transmitting access controller for equipment connected to a CDMA network according to the invention;

FIG. 5 shows an internal architecture of an inter-domain bridge.

The same elements are identified by the same references from one figure to another.

### DETAILED DESCRIPTION OF THE DRAWING

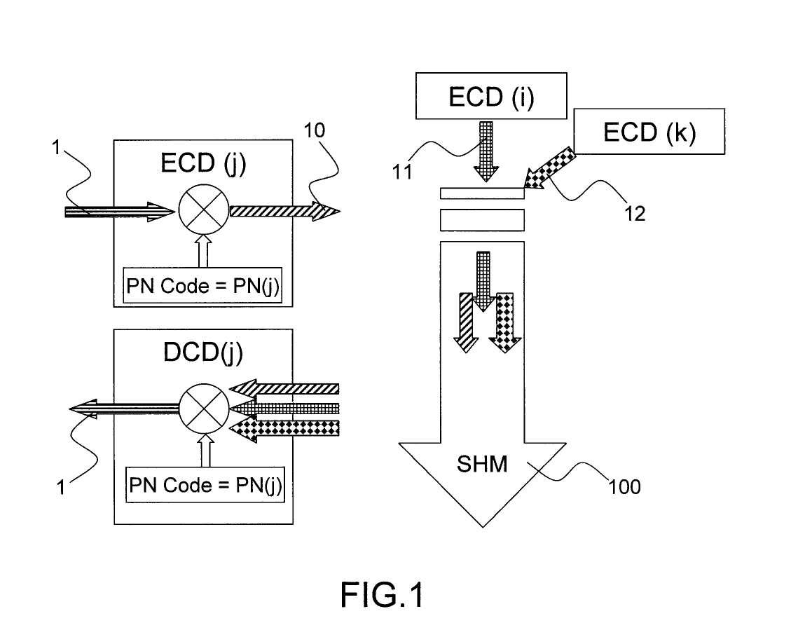

FIG. 1 illustrates the principle of a CDMA network. An encoding device ECD(j) receives a digital message, or a data stream 1 to be transmitted. The digital message 1, is encoded with a pseudo-random code PN(j) specific to the transmitter. An encoded message 10 is transmitted over a shared medium, 100, at the same time as other encoded messages 11, 12, simultaneously transmitted by other transmitters ECD(i), ECD(k). i, j and k are indices that identify equipment in a one-to-one fashion.

On reception, a decoding device DCD(j) indiscriminately receives all the messages present on the shared medium, 100. This encoded data stream is compared with the pseudo-random code PN(j) of an expected transmitter. The comparison is made by means of correlation series. The data stream is successively correlated with the code PN(j) by introducing time delays between the code and the data stream. The data stream and the code are thus synchronized. The maximum value of the result of these successive correlations corresponds to the digital message 1 resulting from decoding the encoded message 10.

In what follows, a CDMA communication network describes a communication network integrating a MAC layer using CDMA technology.

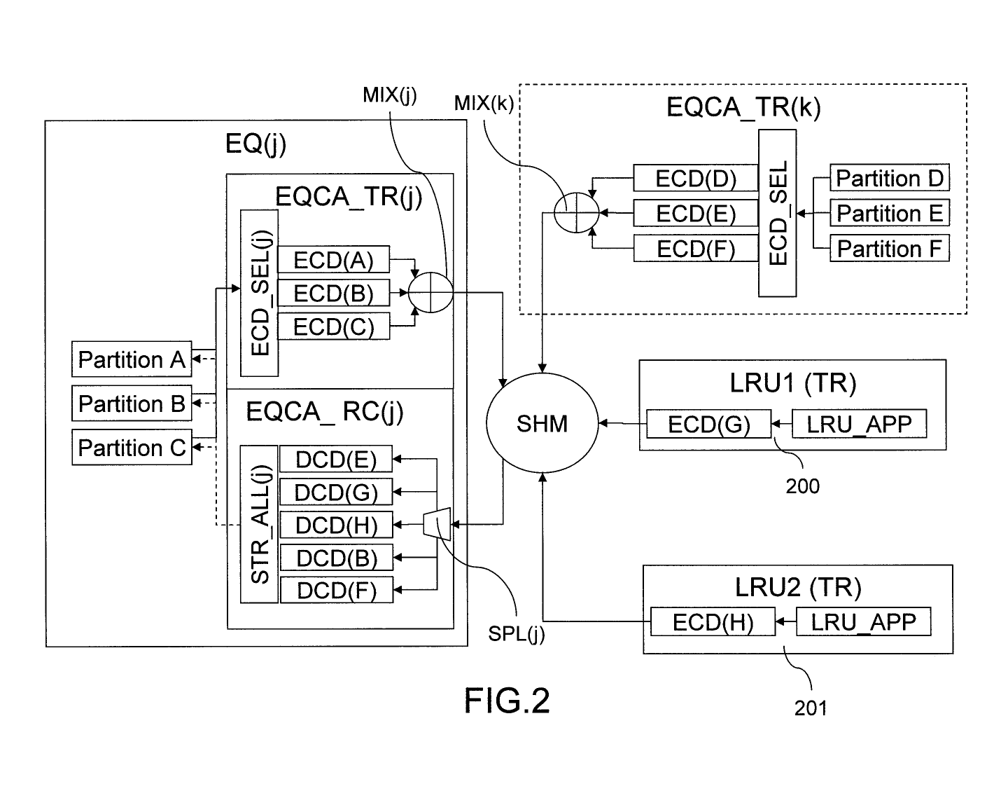

FIG. 2 illustrates a network architecture on board an aircraft according to the invention. A piece of equipment EQ(j) meeting for example the IMA (Integrated Modular Avionics) standards connected to a shared medium 100 includes partitions Partition A, Partition B, Partition C, and an access controller providing the interface between the partitions and the shared medium.

Advantageously, the shared medium is an electrical conductor.

Advantageously, the shared medium is an optical conductor.

The access controller comprises a transmission module EQCA_TR(j) and a reception module EQCA_RC(j). The transmission module EQCA_TR(j) is supplied by messages originating from partitions of the equipment EQ(j) and delivers an encoded data stream to a shared medium, 100. The reception module EQCA_RC(j) collects an encoded data stream originating from a shared medium and sends decoded digital messages originating from predefined partitions in the direction of the partitions of the equipment EQ(j). Equipment similar to EQ(j) is also connected to the shared medium. For example, an equipment EQ(k) is shown without showing a corresponding transmission module. A replaceable unit LRU1(TR), LRU2(TR) comprising a single transmission module for example is also connected to the network.

The transmitter module EQCA_TR(j) comprises encoder units ECD(A), ECD(B), ECD(C), an encoder selection unit ECD_SEL(j) and a mixer MIX(j), the receiver module EQCA_RC(j) comprises decoder units DCD(B), DCD(E), DCD(F), DCD(G), DCD(H), a decoder allocation unit DCD_ALL(j) and a separator SEP(j).

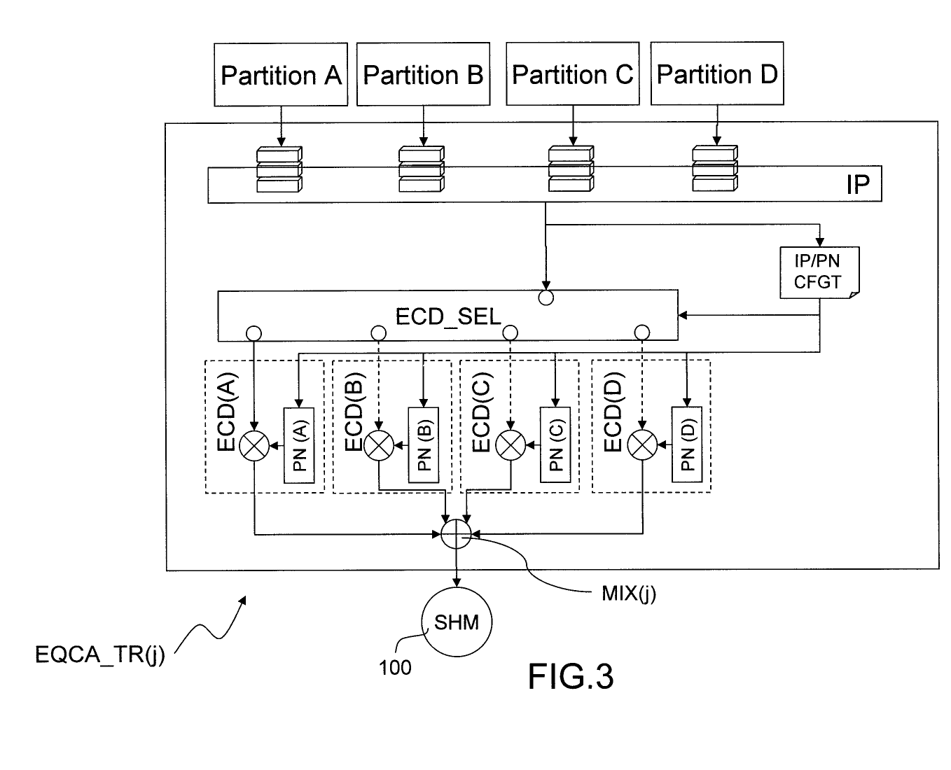

FIG. 3 shows details of the architecture of a transmission module EQCA_TR(j). The partitions of a piece of equipment EQ(j) meeting the IMA standards are identified by an IP (Internet Protocol) address. The transmission module EQCA_TR(j) provides a function which consists in associating a PN code with an IP address, encoding the data with the chosen pseudo-random code then transmitting the encoded data to the shared medium, 100. A correspondence between an IP address and a pseudo-random PN code can be configured either statically or dynamically.

When a partition A transmits data, the IP address of partition A is recognized and stored temporarily in an IP/PN configuration table. A pseudo-random code PN(A) is associated with the IP address, then loaded into a transmission unit ECD(A) identical to that described in FIG. 1. The selection unit of encoder ECD_SEL(j) sends the data to the encoder ECD(A) which encodes it with the pseudo-random code PN(A) and transmits in the direction of a mixer MIX(j) of the transmission module EQCA_TR(j). The mixer MIX(j) finally transmits the data to the shared medium, 100.

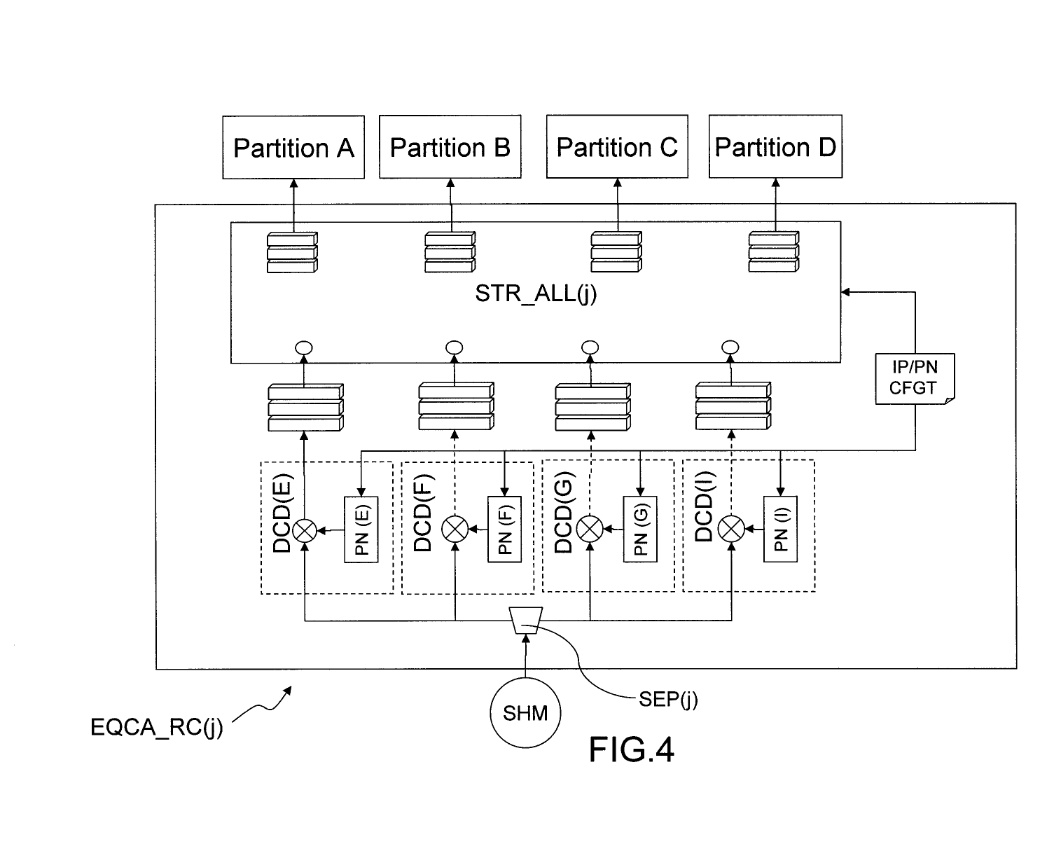

Complementary to this, FIG. 4 shows details of the architecture of a reception module EQCA_RC(j). The reception module EQCA_RC(j) provides a function which consists in routing data present on a shared medium, 100, to partitions of the equipment EQ(j), via the intermediary of a separator SEP(J), reception units, and a stream management device STR_ALL(j).

Each partition must be connected to a stream originating from an IP address. The IP addresses used are associated with a list of pseudo-random codes. The reception module EQCA_RC(j) contains as many reception units DCD(A), DCD(B), DCD(C) as connections to IP addresses; the reception units are identical to that described in FIG. 1. Allocation of the pseudo-random codes to the reception units can be static, in which case a reception unit is permanently associated with a pseudo-random code. Allocation can also be dynamic, in which case the correspondence between the codes and the reception units is periodically examined and where necessary modified in order to poll messages originating from a large number of transmission units without being limited by the number of reception units.

The data originating from the shared medium 100 is decoded by the reception units DCD(E), DCD(F), DCD(G), then stored in a queue before being processed by an IP re-assembly function of the device STR_ALL(j).

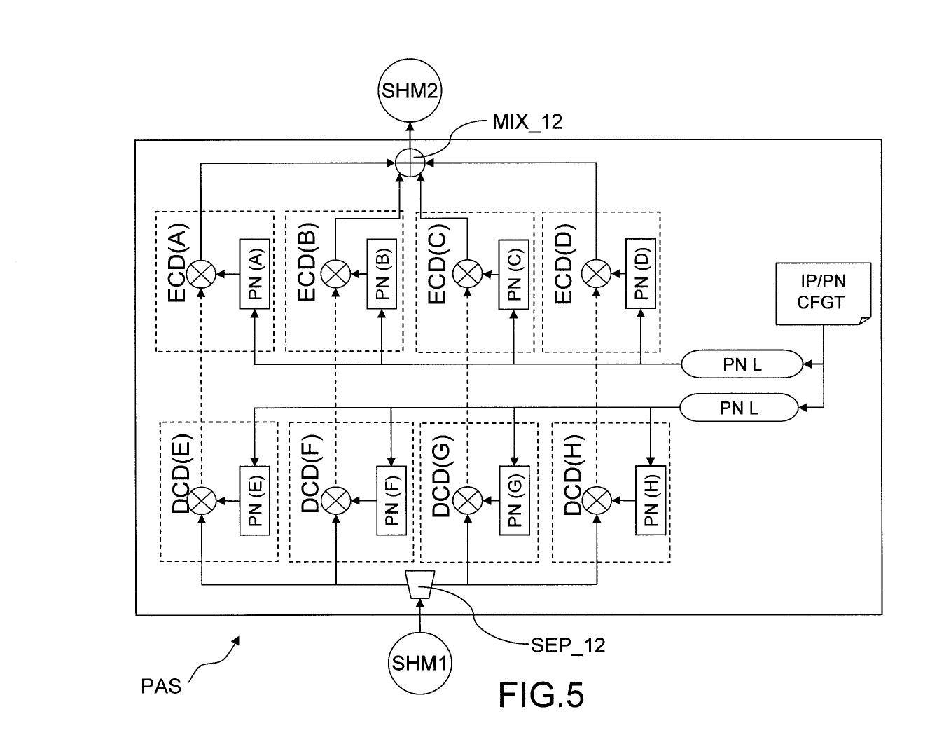

In some network architectures, it is possible to choose to physically connect two on-board networks identical to that shown in FIG. 2. FIG. 5 shows details of the architecture of an inter-domain bridge providing such a connection.

An on-board network joins up equipment cooperating together: it constitutes a domain. To make all the equipment of two separate domains cooperate together, the shared media SHM1, SHM2 of both networks are connected by means of an inter-domain bridge PAS. An on-board CDMA network is thus created which comprises at least two distinct shared media and at least one inter-domain bridge providing an interface between the two shared media.

The role of this bridge is to route information both in the shared medium SHM1 to shared medium SHM2 direction and in the reverse direction. For the purposes of clarity, only the fraction of the bridge routing data from the medium SHM1 to the medium SHM2 is shown in FIG. 5 since it is strictly symmetrical.

Data circulating over the medium SHM1 enters the bridge via a separator SEP_12; it exits through a mixer MIX_12.

When the data enters the bridge PAS, it is first decoded then sent directly to an associated encoder which encodes it with a code specific to the message destination receiving partitions. The architecture of the bridge PAS enables intercommunication between a total number of partitions Nₚₐᵣₜᵢₜᵢₒₙ which is greater than the maximum number of simultaneously exchangeable messages on the shared media SHM1, SHM2. The maximum number of simultaneously exchangeable messages on a shared medium N_{Limit} is defined based on knowing the bandwidth of the shared medium.

Advantageously, the total number of partitions interconnected via the network is greater than N_{Limit}.

1. A CDMA communication network on board a carrier, the network connecting a plurality of equipment on board the carrier and grouped into domains, each piece of equipment having at least one partition, the partitions being able to intercommunicate via digital message exchanges conveyed on at least one shared medium, the shared medium possessing a bandwidth limiting the number of simultaneously exchangeable messages to N_{Limit}, said network comprising:
access controllers providing an interface between equipment partitions and a shared medium, each piece of equipment including an access controller;
shared media which are passive components and which provide an interface between access controllers of equipment in a domain, and at least two distinct shared media and at least one inter-domain bridge providing an interface between the two shared media.

2. The CDMA communication network according to claim 1, wherein the shared medium is an electrical conductor.

3. The CDMA communication network according to claim 1, wherein the shared medium is an optical conductor.

4. The CDMA communication network according to claim 1, wherein the total number of partitions interconnected via the network is greater than N_{Limit}.

5. The CDMA communication network according to claim 2, wherein the total number of partitions interconnected via the network is greater than N_{Limit}.

6. The CDMA communication network according to claim 3, wherein the total number of partitions interconnected via the network is greater than N_{Limit}.
